(19) United States
(12) Patent Application Publication
(10) Pub. No.: US 2014/0263715 A1
(43) Pub. Date: Sep. 18, 2014

(54) Floating Water Delivery Device

(71) Applicants: Mark Fuller, Sun Valley, CA (US); Don Lariviere, Sun Valley, CA (US)

(72) Inventors: Mark Fuller, Sun Valley, CA (US); Don Lariviere, Sun Valley, CA (US)

(21) Appl. No.: 14/210,900

(22) Filed: Mar. 14, 2014

Related U.S. Application Data
(60) Provisional application No. 61/800,370, filed on Mar. 15, 2013.

(51) Int. Cl. B05B 17/08

(52) U.S. Cl. CPC B05B 17/08
USPC 239/18; 239/17

(57) ABSTRACT

A water delivery device that may float on a body of water is described. The device may comprise a buoyant sphere that houses a water shooting device. The device may include fins to help stabilize the sphere against recoil when water is shot from the device. Clips may be included on the device to tether multiple devices together or to the bottom or side of the body of water. The device may include lighting effects to the water shooting out of the device or lighting effects on or from inside the sphere.

### CROSS REFERENCE TO RELATED APPLICATION

The application claims the benefit of U.S. Provisional Application No. 61/800,370, filed Mar. 15, 2013, the contents of which are incorporated herein by reference.

### FIELD OF THE INVENTION

The present invention generally relates to water displays, including water delivery devices which may shoot out water while the device is itself floating on a body of water.

### BACKGROUND OF THE INVENTION

Various water displays exist, many of which include different types of water delivery devices that shoot water into the air. Oftentimes, the water display is located in a reservoir having a bottom and walls. Before the reservoir is filled with water, a network of water delivery devices may be attached to the bottom of a reservoir. This may include the water delivery devices themselves, as well as supporting lines such as electrical, water supply and other lines. After the reservoir is filled, water generally surrounds the water delivery devices, but the outlet of the water delivery device typically remains above the reservoir water level.

These existing water delivery devices may provide dramatic visual effects, but if they are fixed to the bottom of the water reservoir, significant effort may be required to remove them for maintenance or to replace or reposition them to change the display. To this end, the reservoir must typically be drained, and then the water delivery device(s) must be detached from the reservoir floor and relocated or replaced. Besides the water delivery device itself, supporting lines may also need to be replaced or removed. This may all add up to significant time and cost. And these costs are oftentimes incurred because displays often exist in a given location for significant time. Accordingly, they typically require maintenance and the display owner oftentimes wants to enhance or otherwise change the display to prevent it from becoming outdated.

Accordingly, there is a need for a water delivery device for use in a water display that may be more easily maintained or relocated. To this end, there is a need for such a device that does not require draining the display reservoir for maintenance or relocation. There is also a need for a water display having water delivery devices that may be otherwise readily moved if it is desired to change the overall configuration of the water display.

### SUMMARY OF THE INVENTION

In a first aspect of the invention, a floating water delivery device is described. The water delivery device may comprise a hollow sphere, for example, having the size of a large beach ball and possibly rigid in form. The spheres may also be non-rigid in form, and comprise other shapes, such as cubes or dodecahedrons. The sphere may house a water shooter. The water shooter may be firmly attached to the sphere and may hang partly or substantially out of the bottom of the sphere. The sphere is preferably buoyant so that it may float on the surface of a body of water and resist submerging due to recoil caused by the force of water being shot out of the water shooter. The sphere may also include a hole at its top for the stream of water to pass through after it leaves the water shooting device.

In another aspect of the invention, the center of gravity of the water delivery device is relatively low because the water shooter may be positioned so that the majority of its weight is located below the midpoint line or near the bottom of the sphere. To this end, the water shooter may protrude below the bottom of the sphere thereby further lowering the center of gravity of the overall water delivery device. This preferably helps the water delivery device from tipping over from recoil due to the force of the water leaving the water shooter. The floating water delivery device may also include vertical plates or a keel located under water to minimize rocking caused by recoil.

Another aspect of the invention may involve lighting. To this end, the sphere may include lighting elements that may illuminate the water as it leaves the device. The sphere may also be translucent and may include additional lights that may cause the sphere to glow as it floats on the water.

In another aspect of the invention, the pattern in which the floating water delivery devices are arranged may be readily changed because they need not be fixedly attached to the reservoir floor with cumbersome attachment means. To this end, the spheres of multiple floating water delivery devices may be tethered together to form a desired pattern. Some number of spheres may be tethered to the reservoir floor so that the overall pattern of spheres is anchored thereto. The spheres may be attached together and to the reservoir floor in a quick-release fashion so that they may be quickly released from each other and from the reservoir floor. Accordingly, the current invention provides the ability to change the appearance and choreography of the overall water display.

### BRIEF DESCRIPTION OF THE DRAWINGS

FIG. 1 is a cross-section view of a floating water delivery device floating on the surface of a body of water.

FIG. 2 is a top view of the floating water delivery device.

FIG. 3 is a cross-section view showing the floating water delivery device including holes in the sphere for light effects.

FIG. 4 is a cross-section view of a water delivery device showing possible configurations of stabilizing fins on the sphere and water shooter.

FIGS. 5A and 5B are top and cross-section views, respectively, of another embodiment of the invention that includes a hinge to allow access to the inside of the sphere.

FIG. 6 is a cross-section view showing several water delivery devices tethered together and tethered to the floor of the reservoir.

FIG. 7 is a cross-section view of a water delivery device floating on the water surface.

FIG. 8 shows an arrangement of floating water delivery devices in the form of a square.

FIG. 9 shows an arraignment of floating water delivery devices in the form of a line.

FIG. 10 shows an arrangement of floating water delivery devices in the form of a hexagon.

FIG. 11 shows an arrangement of floating water delivery devices in various forms.

### DETAILED DESCRIPTION OF THE PREFERRED EMBODIMENTS

The water delivery device 10 of the current invention is now described with reference to the figures. Where the same or similar components appear in more than one figure, they are identified by the same reference numeral.

In general, one or more water delivery devices 10 of the current invention may form part of water display 1 that may be housed by pool or reservoir 2. Pool or reservoir 2 may include floor 3 and walls 4. After pool 2 is filled with water 5, pool 2 generally has a water surface 6. FIGS. 8-12 show examples of different displays 1 in reservoir 2. As shown, a number of devices 10 may be arranged to form different displays 1. Though these displays 1 show most or all of the devices 10 tethered together, they all need not be connected.

FIG. 1 shows an embodiment of water delivery device 10 floating in the water 3 of reservoir 2. As shown, water delivery device 10 may float on the surface 6 of the water 3. Water delivery device 10 may comprise two main assemblies, the water shooter 20 and the sphere 30. Water may generally be shot out of a hole 31 at or near the top of sphere 30.

An example of a water shooter 20 is more fully described in Provisional patent application 100008-100002, the contents of which are expressly incorporated by reference as if fully set forth herein. Other examples of water shooter 20 that may be provided by WET Design, Inc. are described in the following article, the contents of which are expressly incorporated by reference as if fully set forth herein: Making Water Dance, Jan. 9, 2003, Machine Design.com. The article may be found at: http://machinedesign.com/article/making-water-dance-0109.

It is preferred that water shooter 20 be located along the central axis of sphere 30 so that the overall device 10 may be balanced. This balancing may help reduce the effects of recoil when water shooter 20 shoots water. Water shooter 20 may also be placed off of the central axis and/or be oriented on a non-vertical axis in sphere 30. This may result in water shots having different angles of trajectory. FIG. 2 shows a top view of another water delivery device 10. Again, in this example, water shooter 20 may be placed along the central vertical axis of sphere 30.

Water shooter 20 may comprise various shapes and sizes to accommodate the desired water display effects such as the height that water is desired to shoot into the air. In any event, it is preferred that the size and shape of water shooter 20 are such that sphere 30 may still be buoyant on the water surface 6.

Water shooter 20 may include body 25 and nozzle 40. Body 25 may generally include an internal chamber to hold water that is forced out by compressed air or some other means. The compressed air may be provided by air line 100 that may be connected to shooter 20 at its proximal end and connected to a source of compressed air “on shore” at its distal end. For example, air line 100 may be connected to an air source incorporated into or below reservoir floor 3, reservoir wall 4, an equipment or control room associated with display 1, or at some other location. The compressed air may be delivered to an air chamber within body 25 or attached to it, and when released, may propel the water through nozzle 40. Nozzle 40 may be designed to shoot the water out in a certain configuration, e.g., column of water, fan or other configuration.

After water is shot out of shooter 20, water intake valve 90 may be used to refill the shooter 20 for a subsequent shot. Water intake valve 90, as shown in FIG. 1, may comprise various materials, shapes, and sizes to accommodate the amount of water that may be shot from water shooter 20 as well as the dimensions of reservoir 2. For example, water intake valve 90 may be, but is not limited to, a one way check valve which may refill the internal water chamber from reservoir 2 after each shot. Water intake valve 90 may be located in various areas of water shooter 20, but is preferably on or near the bottom of body 25 so as to facilitate the refilling of water.

As shown in FIG. 1, electrical line 110 may also extend from an “on shore” location and connect to shooter 20. Alternatively, electrical line 110 may connect to sphere 30. As shown, electrical line 110 may wrap around air line 100 but lines 100, 110 may instead extend separately to device 10. As discussed later, electrical line 110 may provide power for lighting and other functions.

The manner in which water shooter 20 and sphere 30 may be attached is now further discussed with reference to FIGS. 1-7. Sphere 30 may comprise various sizes to accommodate the size and directional forces created by water shooter 20. Sphere 20 preferably comprises a buoyant material and is large enough so that the air within provide sufficient buoyancy to support water shooter 20 so that the overall device 10 may float on the surface 6 of the water.

The height of sphere 30 may also be chosen to provide sufficient room to allow water shooter 20 to attach to sphere 30 at various heights along the shooter body 25. As shown in the figures, water shooter 20 may generally be housed by sphere 30 in a “plumb bob” configuration where a certain length of the shooter body 25 may reside 25 within sphere 30 while the remaining length of the shooter body 25 may resides outside sphere 30. For example, water shooter 20 may be mostly contained within sphere 30 as shown in FIGS. 1, 4 and 6. Alternatively, water shooter 20 may be housed lower down in sphere 30 as shown in FIGS. 3, 6 and 7.

The relative height at which water shooter 20 is placed within sphere 30 may relate to the lateral stability of sphere 30 in response to various factors. This may be important because it is generally preferred that when device 10 makes a water shot, the sphere 30 and water shooter 20 are generally pointed vertically or upwards.

Lateral instability may be caused by several factors. For example, the tendency of sphere 30 to deviate from a completely vertical or otherwise upright orientation may be caused by recoil from a water shot. Water shooter 20 may be placed within sphere 30 to shoot off of the central axis which may further cause sphere 30 to sway. Random waves in the reservoir 2 from wind, wind itself or other causes may also cause sphere 30 to rock. Waves generated by water shots of adjacent devices 10 may also cause sphere 30 to rock.

The amount of rocking experienced by sphere 30 may be mitigated by the height at which water shooter 20 is located relative to sphere 30. Generally, the lower the position of water shooter 20 relative to sphere 30, the lower the center of gravity of device 10 and the less susceptible it may be to rocking. However, the depth of the reservoir water 3 may constrain just how much of water shooter 20 may extend below the bottom of sphere 30. Accordingly, water shooter 20 may be housed by sphere at a desired height to account for these factors.

Besides the relative height of water shooter 20 relative to sphere 30, the lateral stability of device 10 may be enhanced through the addition of fins or keels 50 located on either or both water shooter 20 and sphere 30. As shown in FIG. 7, keel 50 may be attached to the bottom of water shooter 20 and may provide a surface area that may be positioned so that it is perpendicular to the direction of anticipated motion. As shown in FIG. 2, keels or fins 50 may be positioned in different locations in anticipation of rocking in several directions. Keels or fins 50 may assume different shapes and sizes.

The lateral stability of spheres 30 may also be enhanced by tethering multiple spheres 30 together, as shown in FIGS. 6 and 11. Tethering may increase lateral stability for several reasons. First, tethers 90 may become taut between water display devices 10 when any of the rock. As tethers 90 become taut, they will help prevent further rocking. Second, tethers 90 also have a certain amount of weight that may act to keep spheres in a stable position as shown in FIG. 6.

Tethers 90 may be of any length suitable for display 1. For example, cables may be between 1′-30′ or some other size. This may depend, for example, on the size of reservoir 2, the configuration of display 1 and other factors. Different lengths of tethers 90 may be used within a display 1 and any range recited herein is in no way a limitation on the scope of the invention. Tethers 90 may comprise various materials such as rubber, rope, composite materials or other materials. It is preferred that tethers 90 exhibit water resistance. Tethers 90 may be flexible which may be preferred to provide some amount of give. Alternatively, tethers 90 may be rigid.

Sphere 30 is now further described. As noted above, sphere 30 preferably comprises a buoyant material. Possible materials include synthetic materials such as polyethylene, lightweight steel, aluminum, polystyrene foam, infused aerogel, water resistant wood, carbon fiber, or any other buoyant material or combination of materials.

Alternatively, sphere 30 may be filled with gases such as air or helium to provide buoyancy. On this configuration other materials which may not otherwise exhibit buoyancy may be used. Such materials for sphere 30 include, but are not limited to, metals, alloys, lightweight stone, dense polyethylene plastic, glass, or carbon fiber. Further, to add buoyancy to water display device 10, buoyant material may be attached within or outside of sphere 30. For example, Styrofoam may be added within sphere 30 to increase buoyancy. Fins or keels 50 may also be added to provide buoyancy. Buoyant material may be attached through the use of water resistant adhesives or mechanical fasteners. If sphere 30 is configured to have holes for lighting, which may allow water to enter the sphere, separate water-tight chambers may reside within or outside sphere 30, which includes buoyant materials or gases.

The tendency of device 10 to recoil in response to a water shot and/or the extent of recoil may be reduced by the buoyancy of sphere 30. That is, as buoyancy increases, a given force from a water shot will cause device 10 to submerge less. And as noted above, the addition of fins or keels 50 under sphere 30 may also reduce or prevent recoil.

The material comprising sphere 30 may be various colors, clear and/or translucent. Numerous devices 10 may be configured together as discussed in more detail later. The use of varying colors, as well as clear, opaque and translucent spheres 30 may add variety to display 1. As discussed later, lighting may emanate from spheres 30, so beyond the color of sphere itself, the appearance of sphere 30 may be enhanced by such lighting. The surface of sphere 30 may be treated to provide water resistance and/or to preserve any color or surface treatment.

The interior of sphere 30 may be substantially free of equipment and may contain holes 70 in which lighting elements 72 may be attached, or through which light 75 may exit as shown in FIG. 3. Where light elements 72 are attached to holes 70, they may be powered by suitable elements (not shown). Individual light sources may be fixed to the inner surface of sphere 30 to project light of various colors, intensities, and frequencies out of holes 70. And where sphere is translucent, the light source may provide that sphere 30 appears to glow in a particular color. As shown in FIG. 7, an LED ball light 73 may be used to provide this glowing effect.

As also shown in FIG. 7 LED stream light 74 may be mounted at or near the top hole 31 in sphere 30 so that the water being shot out of device 10 may be illuminated thereby. That is, lighting elements, such as stream light 74, may be used to shine light upward through the top hole 31.

The lighting within sphere 30 may be changed so that the device 10 and the water it shoots out may vary in color. Colors may change under manual or computer control and may correspond to music or other media.

Even though sphere 30 may lose some buoyancy due to holes such as top hole 31 and lighting holes 70, it is preferred that sphere 30 still provide buoyancy through the material used for its construction as well as the air or other gas contained therein. Chambers of air or gas may be contained within sphere 30 to separate them from the rest of sphere having a hole to the atmosphere.

Additional aspects of fins and keels 50 are now discussed with reference to FIG. 4. As shown, sphere 30 may contain fins 50 to provide additional buoyancy and stability. Fins 50 provide additional stabilization by resisting the rolling motion that may accompany the recoil when water is discharged at high velocities from water shooter 20. Fins 50 may be comprised of various materials, shapes, and exit angles from sphere 30. Water shooter 20 may also contain fins 50 of various materials, shapes, and exit angles. Horizontal fins 50 may mitigate the downward movement of display 10 from the recoil of water shooter 20 and, in addition, may mitigate rocking as well. Vertical fins 50 mitigate tipping or rocking of display 10. Keel 50 may allow for directional control of water display device 10. Lighting device 65 may be included in water display device 10 on or near nozzle 40 or holes 70 to accomplish lighting effects in addition to water display effects. Lighting device 65 may be comprised of, but is not limited to, LEDs lights and other lighting mechanisms.

The aspect of the current invention that allows floating water delivery devices 10 to be easily configured and reconfigured is now described. As shown in FIG. 3, brackets 120 may be mounted to water shooter 20 and/or sphere 30. Clip 122, may be attached to bracket 120. Clip 122 may also be attached to an anchoring line 124 that is itself coupled to the reservoir floor 3. Clip 122 may comprise a standard locking or unlocking carabiner so that anchoring line(s) 124 may be quickly attached to or removed from device 10. This allows device 10 to be quickly removed for maintenance or other reasons. This also allows device 10 to be quickly relocated to alter display 1.

The number and location of clips brackets 120 on sphere 30 and/or water shooter 20 may vary. To this end, brackets 120 may be located so as to clip in tethers 90 which may themselves have clips 122 attached at their ends. Clip 120 allows water display device 10 to be tethered in place relative to other water display devices 10 or tethered to the sides or bottom of the reservoir.

Brackets 120 and clips 120 allow for quick reconfiguration of water display 1 because tethers 90 and anchor lines 124 may easily be detached, moved, reconfigured, and re-attached through the use of quick release devices 122. This feature allows for rapid and extensive reconfiguration with minimal effort and without the end to drain the reservoir. For example, FIGS. 8-12 show different configurations for display 1. As shown, devices 10 may be connected by tethers 90. But with the quick release function of clips 122, the design of FIG. 8 may be changed to that of FIG. 9 or FIG. 10.

Furthermore, not each device 10 needs to be anchored by a line 124 to the reservoir floor 3. Instead, only some number of anchor lines 124 may be needed to keep the display 1 in place. For example, display 1 of FIG. 9 may need anchor lines 124 attached to only devices 10 at the end of the line. As another example, only the four devices 10 comprising the square of hexagonal display 1 in FIG. 10 may need to be anchored.

In any event, the fact that not all devices need to be anchored to the reservoir floor 3 is another reason why displays 1 of the current invention may be quickly changed. This is in sharp contrast to other existing displays where each water shooter or other water delivery device is anchored to the reservoir floor. In this situation, the water would need to be drained and each device would need to be detached. But with the current invention, only some number of anchor lines 124 need be quickly disconnected, and an individual or other means may be used to move device 10 to another location.

Further, device 10 may not be anchored at all. Artistic design may be achieved by allowing device 10 to randomly float about within reservoir 2. The design features included in device 10 to minimize the effects of rocking and recoil may also be decreased or removed to facilitate device 10 movements within reservoir 2 In such a configuration, water exiting devices 10 and display 1 itself may be randomized producing a much different overall display.

Another aspect of the ease in which water display devices 10 may be moved involves the water, air, electrical for shooter actuators or lighting and/or other lines or cables 200 that may extend from “on shore” to devices 10 as shown in FIG. 6. Cables 200 may be of various sizes, shapes, and materials, and may vary in length depending on the number of devices 10, the overall size of the water display 1, and overall size of the display reservoir 2.

Cables 200 may comprise of many separate air lines and electrical wires that may branch out to individual water display devices 10 as seen in FIG. 10. A configuration of this type may allow easier alterations and reconfigurations of water displays because in current display, water shooters or other display devices are traditionally bolted or otherwise attached to the floor of the reservoir. Further, cables 200 may allow for easier movement of air lines and electrical wiring because the lines are attached only to the freely movable water display devices and the power source.

In general, it is relatively easy to move these lines since they may not need to be anchored to the reservoir floor 3 themselves. Instead, they may simply follow device 10 as it is moved across the water surface 6. Furthermore, the amount of air, water or electricity required by water shooter 20 may be less than that needed for existing displays. This may render the supply lines smaller and easier to move.

Another aspect of the ease in which display 1 may be reconfigured is now discussed with reference to FIG. 11. As shown, display 1 may comprise two sections, i.e., devices 10 on the left that include water shooters as shown by the top holes 31 on spheres 30, and devices 10 on the right which may not include water shooters 20 given that there are no top holes 31 in spheres. Display 1 may generally start off in this configuration because the display owner did not have or desire to spend the money or time to install a display where each and every device 10 included a water shooter and the associated cables 200. To this end, devices 10 on the right may only comprise colored spheres with or without lighting. But as time goes on, the display owner may wish to convert the lower cost devices 10 to more versatile devices having water shooters. The lower cost devices 10 may be easily replaced with water shooter devices 10 by simply unclipping the old devices from tethers 90 and any anchor lines 124 that may exist and clipping in new devices 10 with water shooters 20.

An additional design construction of sphere 30 is now described with reference to FIGS. 5A and 5B. FIG. 5A is a top view and FIG. 5B is a side view of sphere 30 that may comprise of two half spheres 35 that may be connected by a hinge 130 or other connector. Further, the half spheres 35 may have interlocking joints or ridges that allow the half spheres 35 to connect without the use of external mechanical fasteners. This configuration may allow easy access for possible repair or alteration to the internal components of such as water shooter 20 or light effects. The half spheres 35 may be designed from the same materials as spheres 30 discussed above.

Water tight seals between the half spheres 35 may be achieved through the use of pressure seals or other similar methods. To this end, pressure seals, gaskets or other means may be used between shooter 20 and sphere 30 and other components of device 10 to prevent or reduce water leakage.

An additional design construction to allow water shooter 20 to be placed at a lower level inside sphere 30 is now described. As seen in FIG. 3, tube 80 may be fixed to nozzle 40 and hole 70 with sphere 30. This configuration may allow for water shooter 20 to be set at a lower level within sphere 30. Tube 80 may be comprised of various shapes, sizes, and materials, including but not limited to, metal, plastic, wood, glass, or carbon fiber. Further, tube 80 may shape or alter water exiting water shooter 20 and nozzle 40.

An additional design of water display device 10 is now described. Water display device 10 may be fitted with compressed air tanks, simple computer programming control, and batteries such that no air lines 100 or electrical wires 110 are required (not shown). For example, water display device 10 may be filled with enough air and power for three 15 minute, pre-programmed displays. Once the shows conclude, a technician may collect water display devices 10 since they are freely releasable and thus movable, and refill, re-power, and re-program for another set of performances.

The ability of the current invention to provide a randomized display is now further discussed. Randomness may be provided by the current invention in various ways. For example, the color of sphere 30 and/or the light emanating from sphere 30 may be random. To this end, the lighting colors may be randomized by a suitable computer program. Furthermore, a few spheres 30, or no spheres, may be tethered together or anchored to reservoir bottom so that they randomly float around reservoir 2. This may evoke the appearance of beach balls floating around a pool.

Still further, the means described above to reduce or prevent the rocking of spheres 30 may not be used. This may result in shooters 20 shooting water out at various, or even haphazard, angles. Some water may even be randomly shot at observers, thereby creating an audience participation effect.

Numerous water display devices 10 may form a system for displays. The system may include devices that do not contain water shooters 20 but do contain possibly less expensive lighting effects. Non-shooting devices may be incorporated into displays that include water display devices 10. The non-shooting devices may then be upgraded by, for example, inserting a water shooter 20, at a possibly lower cost.

Although certain presently preferred embodiments of the invention have been described herein, it will be apparent to those skilled in the art to which the invention pertains that variations and modifications of the described embodiments may be made without departing from the spirit and scope of the invention.

What is claimed is:

1. A water delivery device, comprising:
a buoyant chamber; and
a water shooting device coupled to the buoyant chamber;
wherein the water delivery device floats on or near a water surface.

2. The water delivery device of claim 1, wherein the buoyant chamber comprises a sphere.

3. The water delivery device of claim 1, wherein the water shooting device is coupled to the buoyant chamber so that the water delivery device has a low center of gravity.

4. The water delivery device of claim 3, wherein the water shooting device protrudes through the bottom of the buoyant chamber.

5. The water delivery device of claim 1, further comprising at least one lighting device mounted to the buoyant chamber.

6. The water delivery device of claim 5, wherein the at least lighting device is mounted within the buoyant chamber and the buoyant chamber is translucent.

7. The water delivery device of claim 1, further comprising at least one bracket for receiving a tethering or anchoring line.

8. A water display, comprising at least one water delivery device that floats on or near a water surface, wherein the at least one water delivery device comprises a buoyant chamber and a water shooting device coupled to the buoyant chamber.

9. The water display of claim 8, further comprising a plurality of the water delivery devices, at least some of which are tethered together.

10. The water display of claim 8, further comprising a plurality of the water delivery devices, at least one of which is anchored to a surface below the water surface.

11. The water display of claim 10, wherein the water delivery device anchored to the surface below the water surface is anchored by a quick-release mechanism.

12. The water display of claim 8, further comprising at least one floating device that does not include a water shooting device.

13. The water display of claim 8, wherein at least one of the water delivery devices includes a lighting device mounted to the buoyant chamber.

14. The water display of claim 13, wherein the lighting device is mounted within the buoyant chamber and the buoyant chamber is translucent.
